(19) United States
(12) Patent Application Publication
(10) Pub. No.: US 2023/0097594 A1
(43) Pub. Date: Mar. 30, 2023

(54) INFORMATION PROCESSING DEVICE AND ONBOARD CONTROL DEVICE

(71) Applicant: Hitachi Astemo, Ltd., Hitachinaka-shi, Ibaraki (JP)

(72) Inventors: Riu HIRAI, Tokyo (JP); Hiroaki ITO, Hitachinaka-shi (JP); Hiroo UCHIDA, Yokohama-shi (JP); Goichi ONO, Tokyo (JP); Tadashi KISHIMOTO, Tokyo (JP)

(73) Assignee: Hitachi Astemo, Ltd., Hitachinaka-shi, Ibaraki (JP)

(21) Appl. No.: 17/910,853

(22) PCT Filed: Mar. 12, 2021
(86) PCT No.: PCT/JP2021/010005

§ 371 Date: Sep. 12, 2022

(30) Foreign Application Priority Data
Mar. 25, 2020 (JP) 2020-053749

(51) Int. Cl. G06N 3/04

(52) U.S. Cl. CPC G06N 3/04

(57) ABSTRACT

An information processing device executes a DNN computation by a neural network including a plurality of layers. The information processing device executes a computation process corresponding to a given layer in the neural network, on a first area and on a second area different from the first area, the first and second areas being included in a feature map inputted to the neural network. The information processing device synthesizes a result of the computation process on the first area and a result of the computation process on the second area, and outputs the synthesized computation process results, as a result of the computation process on the feature map.

### TECHNICAL FIELD

The present invention relates to an information processing device and an onboard control device using the information processing device.

### BACKGROUND ART

Conventionally, a technique of recognizing a surrounding situation of a vehicle, based on a captured image from a camera and information from various sensors, and carrying out various forms of driving assist, based on results of the recognition, has been used widely. Development of such a vehicle driving assist technology in recent years has led to a proposal that computations using a neural network that models the functions of the human brain's nerve cells are carried out to obtain highly precise results of recognition of a complicated surrounding situation.

In general, to carry out computations using a neural network in an information processing device (ECU: Electronic Control Unit) incorporated in a vehicle, low power consumption by the computations is required under a restriction that the ECU is run by power supplied from an onboard battery. To meet this requirement, for example, an arithmetic circuit with a relatively small internal memory capacity, such as a small-scale field programmable gate array (FPGA), is used in many cases.

The arithmetic circuit with the small internal memory capacity, however, may fail to store intermediate data, which is generated during computation, in the internal memory. In such a case, it is necessary that at least part of the intermediate data be stored in an external memory device provided outside the arithmetic circuit and that the stored intermediate data be read out of the external memory device when needed in the next round of computation by the arithmetic circuit. However, a data transfer rate between the arithmetic circuit and the external memory device is usually lower than a data transfer rate of the internal memory. This leads to a problem of a lower processing rate.

A technique disclosed by PTL 1 is known as a technique for solving the above problem. PTL 1 discloses a convolutional computation method executed in a neural network, the method including a step of executing a depthwise convolutional computation and a pointwise convolutional computation, using an input feature map read from a DRAM, a depthwise convolutional kernel, and a pointwise convolutional kernel, to obtain output feature values at p points, p representing a first given number, on all pointwise convolutional output channels, and a step of repeating the above computation to obtain output feature values at all points on all pointwise convolutional output channels. PTL 1 states that the above method reduces a memory area for storing intermediate results.

### CITATION LIST

### Patent Literature

PTL 1: JP 2019-109895 A

### SUMMARY OF INVENTION

### Technical Problem

According to the technique of PTL 1, convolutional computations in the neural network are executed as two separate convolutional computations: the depthwise convolutional computation and the pointwise convolutional computation. This poses a problem that part of the information is lost when intermediate results are delivered between these convolution computations, causing a deterioration in recognition precision.

### Solution to Problem

An information processing device according to an aspect of the present invention executes a DNN computation by a neural network including a plurality of layers. A computation process corresponding to a given layer in the neural network is executed on a first area and on a second area different from the first area, the first and second areas being included in a feature map inputted to the neural network. A result of the computation process on the first area and a result of the computation process on the second area are synthesized, and are outputted as a result of the computation process on the feature map.

An information processing device according to another aspect of the present invention executes a DNN computation by a neural network including a plurality of layers. The information processing device includes: a feature map segmenting unit that segments a feature map inputted to the neural network into a plurality of areas such that segmented areas each include redundant sections overlapping each other; an NN computation unit provided in correspondence to each of the layers of the neural network, the NN computation unit executing a given computation process on each of the plurality of areas; an internal memory unit that stores a result of the computation process executed by the NN computation unit; and a feature map synthesizing unit that synthesizes results of the computation processes that the NN computation unit corresponding to given layer of the neural network has executed on each of the plurality of areas, the feature map synthesizing unit storing the synthesized computation process results in an external memory device provided outside the information processing device. A size of the redundant section is determined based on a size of a filter and a stride, the filter and the stride being used in the computation process. The number of segmentations of the feature map by the feature map segmenting unit and the number of layers in the neural network, the layers being subjected to the computation process by the NN computation unit before the feature map synthesizing unit synthesizes the computation process results, are determined, based on at least one of: a memory capacity of the internal memory unit, a total amount of computations by the computation process by the NN computation unit, a data transfer band between the information processing device and the external memory device, and a variation in a data size between a point before the computation process by the NN computation unit and a point after the computation process by the NN computation unit.

An onboard control device according to the present invention includes: the information processing device; and an action plan setting unit that sets an action plan for a vehicle. The information processing device executes the computation process, based on sensor information on a surrounding situation of the vehicle. The action plan setting unit sets the action plan for the vehicle, based on a result of the computation process, the result being outputted from the information processing device.

### Advantageous Effects of Invention

According to the present invention, an information processing device that carries out computation, using a neural network, can increase a processing rate without causing a deterioration in recognition precision.

### BRIEF DESCRIPTION OF DRAWINGS

FIG. 1 depicts a configuration of an onboard control device according to an embodiment of the present invention.

FIG. 2 depicts a configuration of a DNN computation device according to the embodiment of the present invention.

FIG. 3 is a functional block diagram of each of NN computation units making up an arithmetic processing unit according to the embodiment of the present invention.

FIG. 4 depicts an outline of a computation process carried out by the DNN computation device according to the embodiment of the present invention.

FIGS. 5A-5B are diagrams for explaining a method of setting a redundant section, the method being executed by a feature map segmenting unit.

FIG. 6 is a flowchart showing an example of a process of determining the number of segmented areas of a feature map and a storage destination of intermediate data.

### DESCRIPTION OF EMBODIMENTS

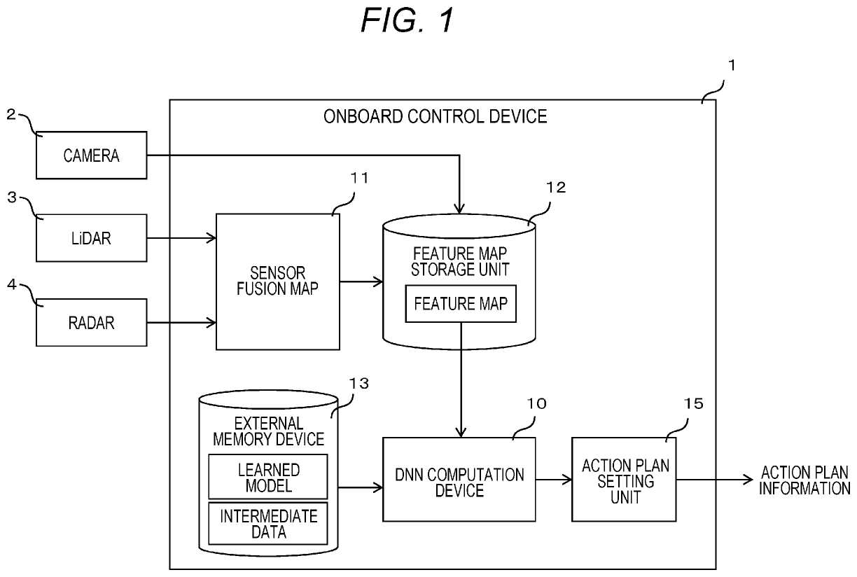

FIG. 1 depicts a configuration of an onboard control device according to an embodiment of the present invention. An onboard control device 1 shown in FIG. 1 is connected to a camera 2, a light detection and ranging (LiDAR) 3, and a radar 4 which are incorporated and used in a vehicle and each function as a sensor for detecting a surrounding situation of the vehicle. The onboard control device 1 receives input of an image of the surroundings of the vehicle, the image being captured by the camera 2, and of distance information indicative of the distance from the vehicle to an object nearby, the distance information being acquired by each of the LiDAR 3 and the radar 4. The vehicle may be equipped with a plurality of cameras 2, LiDARs 3, and radars 4, and captured images and pieces of distance information acquired respectively by the plurality of these sensors may be inputted to the onboard control device 1.

The onboard control device 1 includes a DNN computation device 10, a sensor fusion unit 11, a feature map storage unit 12, an external memory device 13, and an action plan setting unit 15, each of which serves as a functional block. The DNN computation device 10, the sensor fusion unit 11, and the action plan setting unit 15 are each configured using, for example, arithmetic processing circuits, such as a central processing unit (CPU), a graphics processing unit (GPU), a field programmable gate array (FPGA), and an application specific integrated circuit (ASIC), and various programs used in combination with these arithmetic processing circuits. In addition, the feature map storage unit 12 and the external memory device 13 are each configured using a memory device, such as a random access memory (RAM), a hard disk drive (HDD), or a flash memory. It should be noted that the DNN computation device 10 executes DNN computations by a neural network including a plurality of layers, thereby carrying out information processing for recognizing a surrounding situation of the vehicle, and that the DNN computation device 10 is equivalent to an information processing device according to an embodiment of the present invention.

Incoming captured images and pieces of distance information from the camera 2, the LiDAR 3, and the radar 4 are stored in the feature map storage unit 12, as a feature map expressing features of the surrounding situation of the vehicle in the form of pixel values on a two-dimensional plane. Pieces of distance information inputted respectively from the LiDAR 3 and the radar 4 are synthesized through a sensor fusion process by the sensor fusion unit 11, thus being transformed into a feature map that is stored in the feature map storage unit 12. The sensor fusion process, however, does not always need to be carried out. A feature map based on information from other sensors may be stored in the feature map storage unit 12, or either the captured image or the distance information only may be stored in the feature map storage unit 12, as a feature map.

The DNN computation device 10 reads a feature map (captured image or distance information) from the feature map storage unit 12, and executes a deep neural network (DNN) computation on the read feature map. The DNN computation carried out by the DNN computation device 10 is a computation process corresponding to one form of artificial intelligence, that is, computation process executed as a function of a neural network including a plurality of layers. When executing the DNN computation, the DNN computation device 10 acquires necessary weight information from the external memory device 13. The external memory device 13 stores weight information as a learned model, the weight information being calculated in advance by a server (not illustrated) and updated on the basis of learned results of DNN computations having been implemented by the DNN computation device 10. Details of the DNN computation device 10 will be described later.

The action plan setting unit 15 sets an action plan for the vehicle, based on a result of a DNN computation by the DNN computation device 10, and outputs action plan information. For example, the action plan setting unit 15 outputs information for assisting the driver of the vehicle in operating the brake or steering wheel and information for allowing the vehicle to run in autonomous driving mode, as action plan information. Action plan information outputted from the action plan setting unit 15 is put on a display disposed in the vehicle, or is inputted to various electronic control units (ECUs) incorporated in the vehicle and is used for various vehicle controls. Action plan information may be transmitted to a server or a different vehicle.

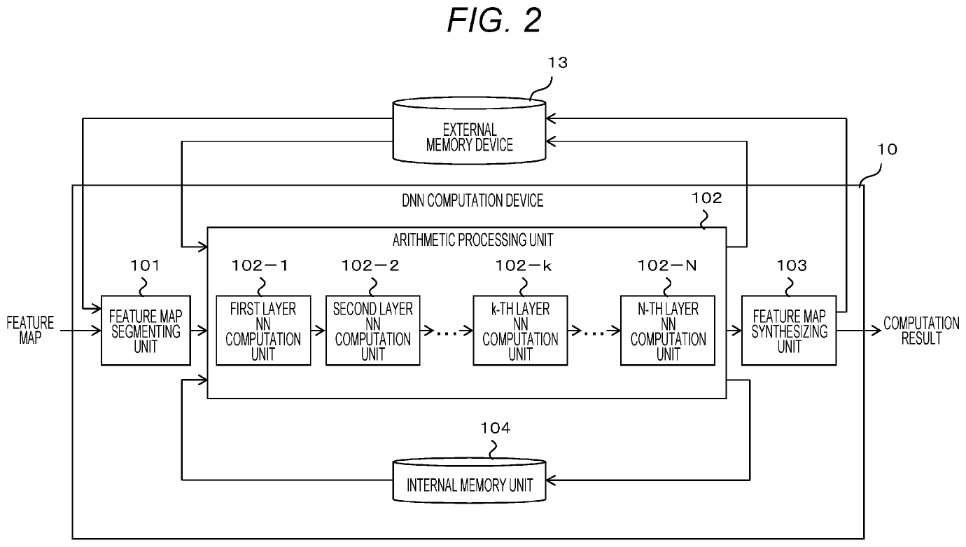

The DNN computation device 10 will then be described. FIG. 2 depicts a configuration of the DNN computation device 10 according to the embodiment of the present invention As shown in FIG. 2, the DNN computation device 10 includes a feature map segmenting unit 101, an arithmetic processing unit 102, a feature map synthesizing unit 103, and an internal memory unit 104.

The feature map segmenting unit 101 segments a feature map, which is read from the feature map storage unit 12 and is inputted to the DNN computation device 10, into a plurality of areas. Details of a method of segmenting the feature map by the feature map segmenting unit 101 will be described in detail later.

The arithmetic processing unit 102 executes the above DNN computation on respective segmented areas of the feature map in sequence, the segmented areas being created by the feature map segmenting unit 101. The arithmetic processing unit 102 includes N layers (N denotes a natural number of 3 or more) of NN computation units arranged in a row, the NN computation units ranging from a first layer NN computation unit 102-1 to an N-th layer NN computation unit 102-N. In other words, in the arithmetic processing unit 102, an N-layer neural network is formed, which is made up of the first layer NN computation unit 102-1, a second layer NN computation unit 102-2, . . . , a k-th layer NN computation unit 102-k, . . . , and an N-th layer NN computation unit 102-N. The arithmetic processing unit 102 sets a weight for each of these NN computation units corresponding respectively to layers in the neural network, and executes a weighted DNN computation, thus deriving a computation result indicating a result of recognition of the surrounding situation of the vehicle, from each area of the feature map. Among the N layers of NN computation units shown in FIG. 2, the first layer NN computation unit 102-1 at the head corresponds to an input layer, and the N-th layer NN computation unit 102-N at the tail corresponds to an output layer.

A computation result produced by each layer of the NN computation unit in the arithmetic processing unit 102 is stored in the internal memory unit 104 or the external memory device 13, as intermediate data, and is delivered to the next layer of the NN computation unit. Specifically, each layer of the NN computation unit, except the input layer, reads intermediate data representing a computation result by the previous layer of the NN computation unit, from the internal memory unit 104 or the external memory device 13, and executes a computation process corresponding to a given layer in the neural network, using the computation result.

The feature map synthesizing unit 103 synthesizes computation results from respective areas, the computation results being obtained by the arithmetic processing unit 102 executing DNN computations on the respective areas in sequence, and outputs the synthesized computation results as a computation result from the DNN computation device 10 while storing the synthesized computation results in the external memory device 13. Hence a result of a DNN calculation on the feature map inputted to the DNN computation device 10 is obtained, and this result can be used by the action plan setting unit 15 to set an action plan for the vehicle.

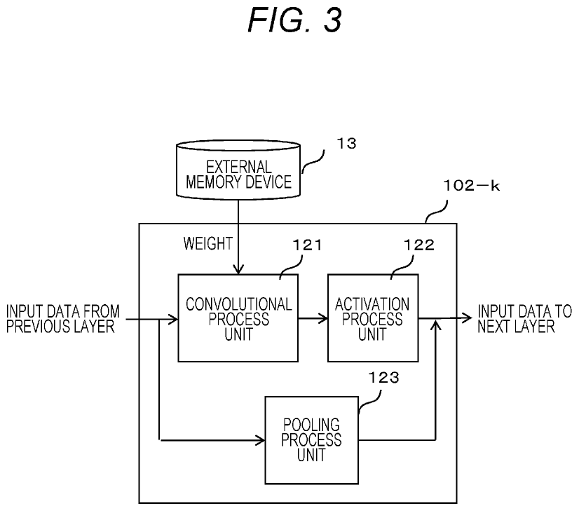

FIG. 3 is a functional block diagram of each of the NN computation units making up the arithmetic processing unit 102 according to the embodiment of the present invention. In the arithmetic processing unit 102, the first layer NN computation unit 102-1 to the N-th layer NN computation unit 102-N each have the same functional configuration. For this reason, FIG. 3 depicts functional blocks of a k-th layer NN computation unit 102-k that represents the first layer NN computation unit 102-1 to the N-th layer NN computation unit 102-N. Hereinafter, the functional blocks of the k-th layer NN computation unit 102-k will be described, which gives description of all NN computation units making up the arithmetic processing unit 102 of this embodiment.

The k-th layer NN computation unit 102-k includes a convolutional process unit 121, an activation process unit 122, and a pooling process unit 123.

Input data outputted from the previous layer ((k−1)-th layer) to the k-th layer NN computation unit 102-k is inputted to the convolutional process unit 121 and to the pooling process unit 123. It should be noted that in the case of the first layer NN computation unit 102-1, each area of a feature map read from the feature map storage unit 12 and segmented by the feature map segmenting unit 101 into segmented areas is inputted to the convolutional process unit 121 and the pooling process unit 123, as input data from the previous layer.

The convolutional process unit 121 carries out a convolutional computation corresponding to the k-th layer in the neural network, based on weight information stored in the external memory device 13 as a learned model. The convolutional computation carried out by the convolutional process unit 121 is a computation process by which when a filter (kernel) of a given size set according to weight information is moved at given intervals on input data, products of respective pixels of the input data within the filter and the corresponding filter elements are summed up at each position of the filter. The intervals at which the filter is moved are called stride.

The activation process unit 122 carries out an activation computation for activating a computation result from the convolutional process unit 121. In this case, for example, the activation process unit 122 carries out the activation computation using an activation function called a rectified linear unit (ReLU) function. The ReLU function is a function that outputs 0 for an input value smaller than 0, but, for an input value equal to or larger than 0, outputs the input value in its as-is state. The activation computation may be carried out, using a function different from the ReLU function. By the activation computation carried out by the activation process unit 122, a data value having less effects on a computation in the next layer (the (k+1)-th layer) is converted into 0, the data value being among data values included in computation results by the convolutional process unit 121.

The pooling process unit 123 carries out a pooling computation corresponding to the k-th layer in the neural network. The pooling computation carried out by the pooling process unit 123 is a computation process by which when a filter of a given size is moved at given intervals on input data, features of respective pixels of the input data within the filter are extracted at each position of the filter. For example, average pooling of extracting an average value of respective pixels within the filter and maximum pooling of extracting a maximum value of respective pixels within the filter are known as pooling computations. The intervals at which the filter is moved in this pooling computation is called stride, as the intervals in the convolutional process by the convolutional process unit 121 is.

Each data value that is given by the convolutional computation by the convolutional process unit 121 and then is subjected to the activation computation by the activation process unit 122 or each data value that is given by the pooling computation by the pooling process unit 123 is outputted from the k-th layer NN computation unit 102-k and is used as input data to the next layer. Each layer of the NN computation unit usually carries out either the convolutional computation or the pooling computation. In the neural network of the arithmetic processing unit 102, the layer of the NN computation unit that carries out the convolutional computation is referred to also as a “convolution layer”, and the layer of the NN computation unit that carries out the pooling operation is referred to also as a “pooling layer”. The NN computation unit of the convolution layer may dispense with the pooling process unit 123, and the NN computation unit of the pooling layer may dispense with the convolutional process unit 121 and the activation process unit 122. Alternatively, each layer of the NN computation unit having the configuration shown in FIG. 3 may be switched in function arbitrarily between the convolutional layer and the pooling layer.

Features of the DNN computation device 10 of this embodiment will then be described. In general, a data transfer band between the arithmetic processing unit 102 and the external memory device 13 is narrower than a bandwidth of the internal memory unit 104 built in the DNN computation device 10. In other words, a data transfer rate between the arithmetic processing unit 102 and the external memory device 13 is lower than a data transfer rate of the internal memory unit 104. To make DNN computation by the DNN computation device 10 faster, therefore, it is preferable that intermediate data produced by each layer of the NN computation unit be stored not in the external memory device 13 but in the internal memory unit 104 as much as possible However, because of hardware-related restrictions on the DNN computation device 10, a memory capacity the internal memory unit 104 is allowed to have is relatively small. For this reason, depending on the data size of a feature map, intermediate data obtained by respective layers of NN computation units cannot be entirely stored in the internal memory unit 104 in some cases.

To deal with this problem, according to the DNN computation device 10 of this embodiment, the feature map segmenting unit 101 segments the feature map into a plurality of areas, and layers of the NN computation units of the arithmetic processing unit 102 carry out computation processes on the respective segmented areas in sequence. As a result, compared with a case where the unsegmented feature map is directly inputted to the arithmetic processing unit 102, the data size of intermediate data outputted from each layer of the NN computation unit is made smaller and therefore can be stored in the internal memory unit 104. Computation results from respective areas, which are outputted from the output layer at the tail, are then synthesized by the feature map synthesizing unit 103 to obtain a result of the DNN computation on the feature map. Hence, even if the memory capacity of the internal memory unit 104 is small, the DNN computation carried out by the DNN computation device 10 is made faster without causing a deterioration in recognition precision based on the feature map.

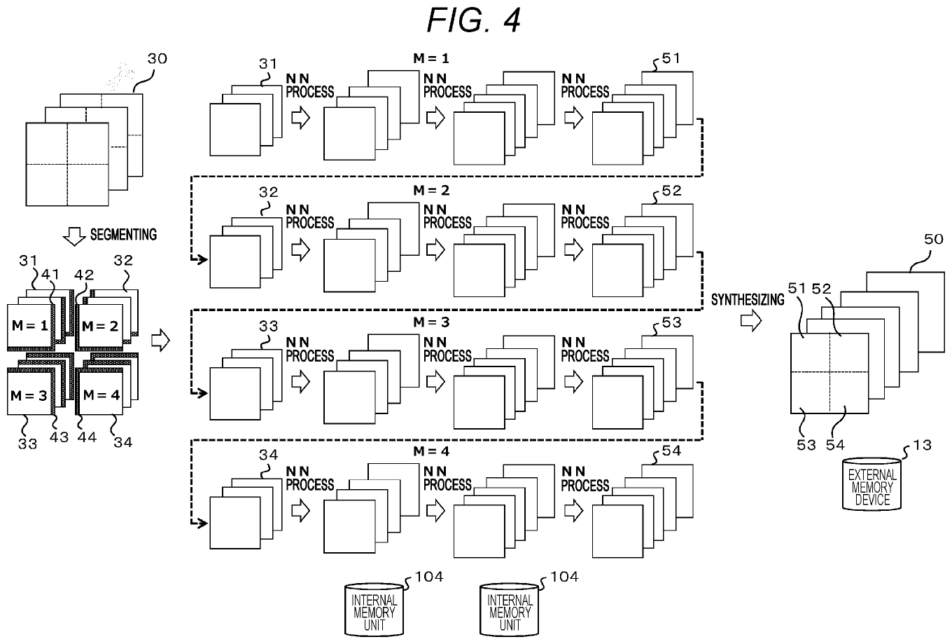

FIG. 4 depicts an outline of a computation process carried out by the DNN computation device 10 according to the embodiment of the present invention.

A feature map 30 inputted to the DNN computation device 10 is first segmented by the feature map segmenting unit 101 into a plurality of areas 31 to 34. FIG. 4 shows an example in which three types of feature maps 30 corresponding to image data of R, G, and B are each segmented into four to create four areas 31 to 34 making up each feature map 30. The number of feature maps and the number of segmentations are, however, not limited to the numbers shown in FIG. 4. In FIG. 4, M is an ID for identifying each area, and IDs ranging from M=1 to M=4 are set in order for the areas 31 to 34, respectively.

The areas 31 to 34, into which the feature map 30 is segmented, include redundant sections 41 to 44, respectively. Among the redundant sections 41 to 44, redundant sections of adjacent areas correspond to the same part in the pre-segmentation feature map 30. For example, a right part of the redundant section 41 included in the area 31 and a left part of the redundant section 42 included in the area 32 commonly correspond to the same part of the pre-segmentation feature map 30, and are therefore identical with each other. A lower part of the redundant section 41 included in the area 31 and an upper part of the redundant section 43 included in the area 33 commonly correspond to the same part of the pre-segmentation feature map 30, and are therefore identical with each other. In other words, the feature map segmenting unit 101 segments the feature map 30 into the areas 31 to 34 such that pairs of adjacent areas include pairs of redundant sections 41 and 42 to 43 and 44, respectively, each pair of redundant sections overlapping each other.

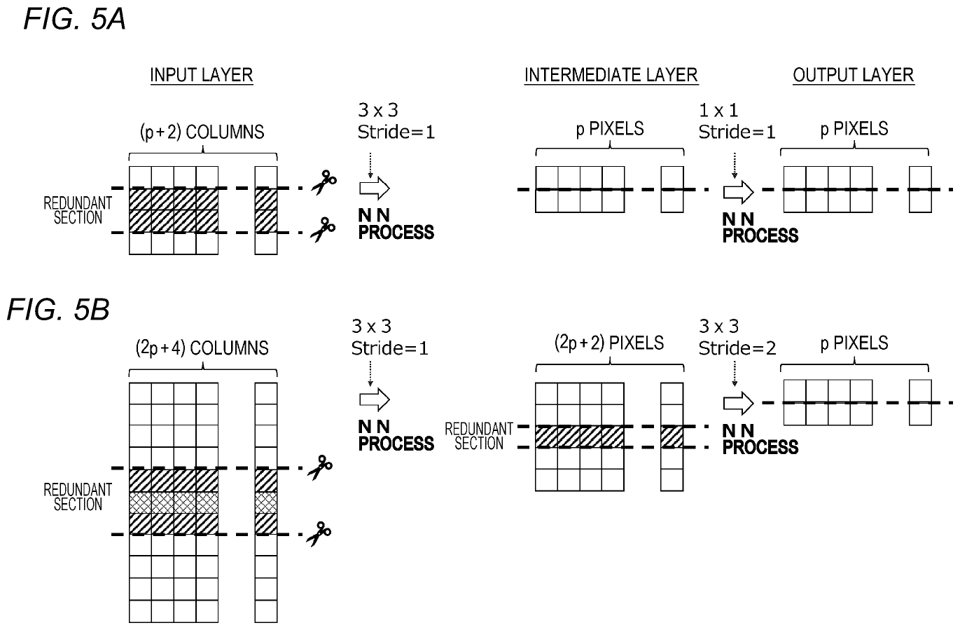

The size of the redundant sections 41 to 44, which are set by the feature map segmenting unit 101, is determined based on the size of a filter and of a stride, the filter and stride being used in the convolutional computation and pooling computation executed by each of the NN computation units 102-1 to 102-N in the arithmetic processing unit 102. This will be further described later with reference to FIG. 5.

The areas 31 to 34, which the feature map segmenting unit 101 creates by segmenting the feature map 30, are inputted to the arithmetic processing unit 102. The arithmetic processing unit 102 sequentially carries out computation processes on the areas 31 to 34 using the NN computation units 102-1 to 102-N corresponding respectively to layers in the neural network, thus executing a DNN computation on each of the areas into which the feature map 30 is segmented. Specifically, a DNN computation on the area 31 (M=1) is executed to obtain output data 51 indicating the computation result, and then a DNN computation on the area 32 (M=2) is executed to obtain output data 52 indicating the computation result. These processes are carried out on the areas 31 to 34 in sequence. As a result, from the areas 31 to 34, output data 51 to 54 corresponding respectively to DNN computation results can be obtained.

During execution of the DNN computation by the arithmetic processing unit 102, intermediate data obtained by each layer of the NN computation unit is temporarily stored in the internal memory unit 104 and is used as input data to the next layer of the NN computation unit. At this time, the data stored in the internal memory unit 104 is rewritten for each layer in the neural network that carries out the computation process. Intermediate data stored in the internal memory unit 104 during execution of the DNN computation on the area 31 and intermediate data stored in the internal memory unit 104 during execution of the DNN computation on the area 32 are, therefore, different in content from each other. This applies also to the areas 33 and 34. In other words, results of computation processes that each layer of the NN computation unit carries out on the areas 31 to 34 are each stored in the internal memory unit 104 at different points of time.

When all DNN computations in the arithmetic processing unit 102 are completed, the output data 51 to 54 from the output layer, the output data 51 to 54 being obtained by the computations on the areas 31 to 34, are inputted to the feature map synthesizing unit 103. The feature map synthesizing unit 103 synthesizes the output data 51 to 54 to generate synthesized data 50 representing a result of the DNN computation on the pre-segmentation feature map 30. Specifically, for example, the output data 51 to 54 based on the areas 31 to 34 are arranged at the positions corresponding respectively to the positions of the areas 31 to 34 into which the feature map 30 is segmented, and are synthesized to generate the synthesized data 50, as shown in FIG. 4. The synthesized data 50 generated by the feature map synthesizing unit 103 is stored in the external memory device 13.

The feature map synthesizing unit 103 may synthesize not only the results of computations on respective areas that are outputted from the output layer of the arithmetic processing unit 102 but also results of computations on respective areas that are outputted from any given intermediate layer among intermediate layers provided between the input layer and the output layer. In other words, the feature map synthesizing unit 103 can synthesize results of computation processes that the NN computation unit 102-(k+α) corresponding to the (k+α)-th layer (α is an any given natural number) in the neural network has executed on respective areas. Furthermore, in this synthesizing process, computation results from an intermediate layer that are stored in the external memory device 13 may be inputted to the feature map segmenting unit 101, where the computation results are segmented into a plurality of areas as the feature map is, and then are inputted to the next layer of the NN computation unit, which carries out a computation process on the segmented areas. In this case, the computation results from the intermediate layer that are synthesized by the feature map synthesizing unit 103 are temporarily stored in the external memory device 13, and then are inputted to the next layer of the NN computation unit, that is, the NN computation unit 102-(k+α+1) corresponding to the (k+α+1)-th layer in the neural network, and are used for a computation process in this layer.

A method of setting a redundant section, the method being executed by the feature map segmenting unit 101, will then be described. When segmenting an inputted feature map into a plurality of areas, the feature map segmenting unit 101 sets the above-described redundant section for each area. The redundant section is set so that in the arithmetic processing unit 102, the NN computation units 102-1 to 102-N are able to accurately execute their respective convolutional computations and the pooling computations, that is, able to obtain the same result as the results that would be obtained when the convolutional computations and the pooling computations are executed on the pre-segmentation feature map. Specifically, the redundant section is set in the following manner, based on the size of a filter and of a stride, the filter and stride being used by each NN computation unit.

FIG. 5 is a diagram for explaining a method of setting a redundant section, the method being executed by the feature map segmenting unit 101. FIG. 5A depicts an example of redundant section setting in which the size of a filter is 3×3 and that of a stride is 1, the filter and stride being used in a computation process in the input layer, and the size of a filter is 1×1 and of a stride is 1, the filter and stride being used in a computation process in the intermediate layer. FIG. 5B depicts an example of redundant section setting in which the size of a filter is 3×3 and that of a stride is 1, the filter and stride being used in a computation process in the input layer, and the size of a filter is 3×3 and that of a stride is 2, the filter and stride being used in a computation process in the intermediate layer. It should be noted that, for simpler description, FIGS. 5A and 5B each depict an example of redundant section setting for a DNN computation in a case of only one intermediate layer being provided between the input layer and the output layer. In a case where two or more intermediate layers are provided, the redundant section can be set by the same method.

To allow a computation process in the input layer to be executed accurately on respective areas into which a feature map is segmented, it is necessary to ensure that applying a filter to respective boundaries of the segmented areas produces the same computation results as computation results that would be produced when the computation process is executed on the pre-segmentation feature map. This applies also to each intermediate layer between the input layer and the output layer. When the feature map is segmented into the plurality of areas, therefore, the feature map segmenting unit 101 determines the size of the redundant section so that the above condition is met in the input layer and each intermediate layer.

In the example of FIG. 5A, because the size of the filter is 3×3 and that of the stride is 1, the filter and stride being used in the computation process in the input layer, a redundant section equivalent in width to two pixels needs to be set for the computation process in the input layer. Meanwhile, because the size of the filter is 1×1 and that of the stride is 1, the filter and stride being used in the computation process in the intermediate layer, no redundant section needs to be set for the computation process in the intermediate layer. Thus, as indicated by a hatched area in the input layer of FIG. 5A, a redundant section equivalent in width to two pixels is set on respective boundaries between the areas into which the feature map is segmented. It should be noted that although a redundant section in the vertical direction is not shown in FIG. 5A, a redundant section equivalent in width to two pixels is set also on a boundary in the vertical direction in the same manner as on the boundary in the horizontal segmentation.

In the example of FIG. 5B, because the size of the filter is 3×3 and that of the stride is 1, the filter and stride being used in the computation process in the input layer, a redundant section equivalent in width to two pixels needs to be set for the computation process in the input layer, as in the case of FIG. 5A. Meanwhile, because the size of the filter is 3×3 and that of the stride is 2, the filter and stride being used in the computation process in the intermediate layer, a redundant section equivalent in width to one pixel needs to be set for the computation process in the intermediate layer. Thus, as indicated by a hatched area in the input layer of FIG. 5B, a redundant section equivalent in width to three pixels, which is the sum of the redundant section for computation in the input layer and the redundant section for computation in the intermediate layer, is set on respective boundaries between the areas into which the feature map is segmented. It should be noted that although a redundant section in the vertical direction is not shown in FIG. 5B, a redundant section equivalent in width to three pixels is set also on a boundary in the vertical direction in the same manner as on the boundary in the horizontal segmentation.

As described above, when segmenting the feature map inputted to the arithmetic processing unit 102, the feature map segmenting unit 101 sums up the numbers of pixels of redundant sections needed for computation processes that are carried out in respective layers of the arithmetic processing unit 102 before output data synthesizing, and determines the size of the redundant section of each of the segmented areas. Specifically, for example, the width W of the redundant section that is set when the feature map is segmented can be determined by the following Equation (1). In Equation (1), Aₖ denotes a filter size in the k-th layer, and Sₖ denotes a stride in the k-th layer. N denotes the number of layers in the neural network, the layers making up the arithmetic processing unit 102, that is, the number of NN computation units.

$$[ Equation 1 ]$$

$$W = {\sum }_{k = 1}^{N - 1} ( {A}_{k} - {S}_{k} ) \qquad ( 1 )$$

A method of determining the number of segmentations of the feature map and a storage destination of intermediate data will then be described. As described above, a computation result by each layer of the NN computation unit in the arithmetic processing unit 102 is stored in the internal memory unit 104 or the external memory device 13, as intermediate data. To make the DNN computation executed by the DNN computation device 10 of this embodiment faster, settings must be made in consideration of the memory capacity of the internal memory unit 104 so that intermediate data produced by each layer of the NN computation unit making up the arithmetic processing unit 102 is stored in the internal memory unit 104 as much as possible. It should be noted, however, that when the size of a stride of a filter used in the computation process in the intermediate layer is 2 or more, a post-computation data turns out to be smaller in size. To keep the required memory capacity of the internal memory unit 104 small, therefore, synthesizing output data obtained by layers preceding the intermediate layer is preferable. It is necessary that these conditions be taken into consideration when the number of segmentations of the feature map by the feature map segmenting unit 101 and a storage destination of intermediate data, the storage destination being either the internal memory unit 104 or the external memory device 13, are determined.

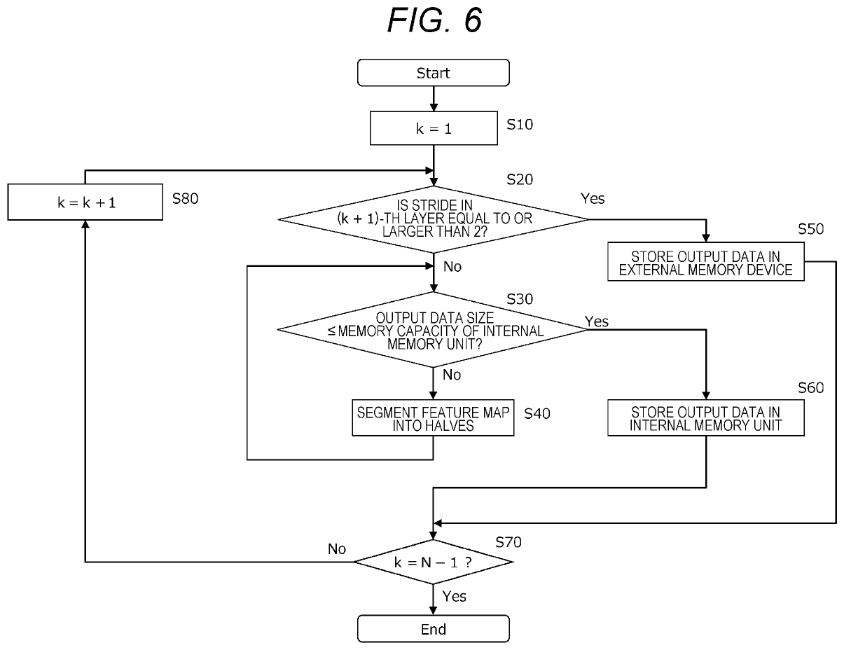

FIG. 6 is a flowchart showing an example of a process of determining the number of segmentations of the feature map and a storage destination of intermediate data. The process shown in the flowchart of FIG. 6 may be carried out by the DNN computation device 10 or by a different unit of the onboard control device 1. Another case may also possible, in which the process shown in the flowchart of FIG. 6 is carried out in advance, using a general-purpose computer or the like, to determine in advance the number of segmentations of the feature map by the DNN computation device 10 and the storage destination of intermediate data, and, based on the determination results, specifications of the DNN computation device 10 is determined.

In step S10, an initial value k=1 is set for the NN computation unit 102-k, which is a target computation unit.

In step S20, whether the size of a stride of the layer next to the k-th layer of the NN computation unit 102-k selected as the current target computation unit, that is, the size of a stride of the (k+1)-th layer of the NN computation unit 102-(k+1) is 2 or more is determined. When the size of the stride of the (k+1)-th layer is 2 or more, that is, when an interval at which the filter used in the computation process by the NN computation unit 102-(k+1) moves is 2 pixels or more, the process flow proceeds to step S50. When the size of the stride is not 2 or more, the process flow proceeds to step S30.

In step S30, whether the size of output data from the NN computation unit 102-k selected as the current target computation unit is equal to or smaller than the memory capacity of the internal memory unit 104 is determined. When the size of the output data from the NN computation unit 102-k is equal to or smaller than the memory capacity of the internal memory unit 104, the process flows proceeds to step S60. When the size of the output data from the NN computation unit 102-k is not equal to or smaller than the memory capacity of the internal memory unit 104, that is, exceeds the memory capacity of the internal memory unit 104, the process flow proceeds to step S40. When the number of segmentations of the feature map is already set by a process of step S40 that has been executed on preceding layers including the previous layer of the NN computation unit 102-(k−1), the determination in step S30 is made by using the size of the output data from the NN computation unit 102-k, the size of the output data being based on the segmented feature map.

In step S40, the feature map segmenting unit 101 determines the number of segmentations of the feature map such that the feature map is segmented into halves. After step S40 is executed, the size of the output data from the NN computation unit 102-k is calculated, based on the data size of each area of the feature map segmented, and then process flow returns to step S30. Thus, until the size of the output data from the NN computation unit 102-k when the feature map is segmented into a plurality of areas becomes equal to or smaller than the memory capacity of the internal memory unit 104, a set value for the number of segmentations of the feature map is increased.

When the process flow has proceeded from step S20 to step S50, the storage destination of output data from the NN computation unit 102-k, which is selected as the current target computation unit, is determined to be the external memory device 13 in step S50. When this process in step S50 is over, the process flow proceeds to step S70.

When the process flow has proceeded from step S30 to step S60, the storage destination of output data from the NN computation unit 102-k, which is selected as the current target computation unit, is determined to be the internal memory unit 104 in step S60. When this process in step S60 is over, the process flow proceeds to step S70.

In step S70, whether k=N−1 holds is determined. When k=N−1 holds, that is, when the NN computation unit 102-k selected as the current target computation unit is the intermediate layer located immediately before the output layer (when the NN computation unit 102-k is the final one of a series of intermediate layers), the whole process shown in the flowchart of FIG. 6 comes to an end. When k=N−1 does not hold, on the other hand, the process flow proceeds to step S80.

In step S80, the value of k is increased by 1 to select the layer next to the NN computation unit 102-k, as the current target computation unit. After this process in step S80 is over, the process flow returns to step S20, from which the above-described processes are repeated. In this manner, the layers of NN computation units making up the arithmetic processing unit 102 are each selected as target computation units in order in which the first layer NN computation unit 102-1 is selected first, and the number of segmentations of the feature map and the storage destination of intermediate data are determined for each target computation unit.

It should be noted that the above method of determining the number of segmentations of the feature map and the storage destination of intermediate data, the method being described with reference to FIG. 6, is merely an example. The number of segmentations of the feature map and the storage destination of intermediate data may be determined by other methods. For example, the number of segmentations of the feature map and the number of layers in the neural network, the layers being subjected to the computation process by each layer of the NN computation unit before the feature map synthesizing unit 103 synthesizes results of computation processes on respective areas, that is, the number of layers of the NN computation units of the arithmetic processing unit 102 that store intermediate data in the internal memory unit 104, can be determined, based on at least one of the following conditions.

(Condition 1) The memory capacity of the internal memory unit 104

(Condition 2) A total amount of computations by the computation process by each layer of the NN computation unit

(Condition 3) A data transfer band between the DNN computation device 10 and the external memory device 13

(Condition 4) A variation in a data size between a point before the computation process by each layer of the NN computation unit and a point after the same

The embodiment of the present invention described above offers the following effects.

(1) The DNN computation device 10 is an information processing device that executes a DNN computation by a neural network including a plurality of layers. The DNN computation device 10 executes a computation process on a first area (e.g., the area 31) and on a second area (e.g., the area 32) different from the first area in the feature map 30 inputted to the neural network, the computation process corresponding to a given layer in the neural network (layers of the NN computation units 102-1 to 102-N of the arithmetic processing unit 102). A result of the computation process on the first area and a result of the computation process on the second area are then synthesized, and are outputted as a result of the computation process on the feature map 30 (feature map synthesizing unit 103). According to this configuration, the information processing device that carries out computation, using the neural network, can increase a processing rate without causing a deterioration in recognition precision.

(2) The DNN computation device 10 includes the feature map segmenting unit 101 that segments the feature map 30 into the first area and the second area. According to this configuration, the inputted feature map can be segmented properly.

(3) The feature map segmenting unit 101 segments the feature map 30 into the first area and the second area such that the first area includes a redundant section and the second area include a redundant section, both redundant sections overlapping each other (e.g., the redundant sections 41 and 42 of the areas 31 and 32). According to this configuration, the NN computation units 102-1 to 102-N of the arithmetic processing unit 102 can accurately execute their respective computation processes on each of the segmented areas.

(4) The size of the redundant section is determined based on the size of a filter and of a stride, the filter and the stride being used in the computation process carried out by each of the NN computation units 102-1 to 102-N of the arithmetic processing unit 102. According to this configuration, when the filter is applied to a boundary between respective segmented areas, the same result as the results that would be obtained when the computation process is executed on the pre-segmentation feature map can be obtained.

(5) The DNN computation device 10 includes: the NN computation units 102-1 to 102-N provided in correspondence respectively to layers in the neural network, the NN computation units 102-1 to 102-N each executing a given computation process on the first area and on the second area; the internal memory unit 104; and the feature map synthesizing unit 103. The internal memory unit 104 stores a result of a computation process on the first area, the computation process being executed by the NN computation unit 102-k corresponding to the k-th layer in the neural network, and a result of a computation process on the second area, the computation process being executed by the NN computation unit 102-k corresponding to the k-th layer, at different points of time. The feature map synthesizing unit 103 can synthesize a result of a computation process on the first area, the computation process being executed by the NN computation unit 102-(k+α) corresponding to the (k+α)-th layer in the neural network, and a result of a computation process on the second area, the computation process being executed by the NN computation unit 102-(k+α) corresponding to the (k+α)-th layer. According to this configuration, results of computations on respective areas, the results being outputted from a given intermediate layer among the intermediate layers provided between the input layer and the output layer in the arithmetic processing unit 102, are synthesized, and the DNN computation is carried out on the synthesized results.

(6) Results of the computation processes, the results being synthesized by the feature map synthesizing unit 103, are stored in the external memory device 13 provided outside the DNN computation device 10. The results of the computation processes, the results being stored in the external memory device 13, may be inputted to the NN computation unit 102-(k+α+1) corresponding to the (k+α+1)-th layer in the neural network. According to this configuration, the computation process in the remaining layers can be executed using synthesized intermediate data. The DNN computation device 10 is thus able to continue its overall DNN computation.

(7) The NN computation unit 102-(k+α+1) corresponding to the (k+α+1)-th layer may execute a convolutional process or pooling process using a stride of 2 or more in size. According to this configuration, when the computation result is stored in the internal memory unit 104, the required memory capacity of the internal memory unit 104 can be reduced in size. When the computation result is stored in the external memory device 13, on the other hand, a data transfer capacity (data transfer band) needed for data transfer between the DNN computation device 10 and the external memory device 13 can be reduced in size.

(8) The DNN computation device 10 includes: the feature map segmenting unit 101 that segments the feature map 30 into the plurality of areas 31 to 34 including at least the first area and the second area; the NN computation units 102-1 to 102-N provided in correspondence respectively to layers in the neural network, the NN computation units 102-1 to 102-N each executing a computation process on each of the areas 31 to 34; the internal memory unit 104 that stores results of the computation processes executed by the NN computation units 102-1 to 102-N; and the feature map synthesizing unit 103 that synthesizes results of the computation processes that the NN computation unit 102-k corresponding to a given layer in the neural network has executed on each of the areas 31 to 34, the feature map synthesizing unit 103 storing the synthesized computation process results in the external memory device 13 provided outside the DNN computation device 10. The number of segmentations of the feature map 30 by the feature map segmenting unit 101 and the number of layers in the neural network, the layers being subjected to the computation processes by the NN computation units 102-1 to 102-k before the feature map synthesizing unit 103 synthesizes the computation process results, are determined, based on at least one of: a memory capacity of the internal memory unit 104 (condition 1), a total amount of computations by the computation process by each layer of the NN computation unit (condition 2), a data transfer band between the DNN computation device 10 and the external memory device 13 (condition 3), and a variation in a data size between a point before the computation process by each layer of the NN computation unit and a point after the same (condition 4). According to this configuration, the number of segmentations of the feature map by the feature map segmenting unit 101 and the number of layers of the NN computation units of the arithmetic processing unit 102, the NN computation units storing intermediate data in the internal memory unit 104, can be determined properly.

(9) The onboard control device 1 includes the DNN computation device 10, and the action plan setting unit 15 that sets an action plan for the vehicle. The DNN computation device 10 executes a DNN computation, based on a feature map representing sensor information on a surrounding situation of the vehicle. The action plan setting unit 15 sets an action plan for the vehicle, based on a DNN computation result outputted from the DNN computation device 10. According to this configuration, the action plan for the vehicle can be set properly, using a result of the DNN computation carried out by the DNN computation device 10.

The embodiment has been described above as an example in which the DNN computation device 10 included in the onboard control device 1 incorporated in the vehicle executes the DNN computation, based on sensor information on the surrounding situation of the vehicle, thereby recognizing the surrounding situation of the vehicle. The present invention is, however, not limited to this example. The present invention may be applied to various information processing devices, providing that the information processing devices execute DNN computations by a neural network including a plurality of layers.

The embodiment and modifications described above are examples. The present invention is not limited to these embodiment and modifications, and may be implemented in other forms on condition that the features of the invention are not impaired. Various embodiments and modifications may be each implemented as an independent embodiment or modification or be implemented as any given combination of embodiments and modifications. The present invention is not limited to the embodiment and modifications described above. Other modes of the invention that can be conceived within a range of the technical concept of the present invention are also included in the scope of the present invention.

### REFERENCE SIGNS LIST

1 onboard control device

2 camera

3 LiDAR

4 radar

10 DNN computation device

11 sensor fusion unit

12 feature map storage unit

13 external memory device

15 action plan setting unit

101 feature map segmenting unit

102 arithmetic processing unit

103 feature map synthesizing unit

104 internal memory unit

121 convolutional process unit

122 activation process unit

123 pooling process unit

1. An information processing device that executes a DNN computation by a neural network including a plurality of layers, wherein
a computation process corresponding to a given layer in the neural network is executed on a first area and on a second area different from the first area, the first and second areas being included in a feature map inputted to the neural network, and
a result of the computation process on the first area and a result of the computation process on the second area are synthesized, and are outputted as a result of the computation process on the feature map.

2. The information processing device according to claim 1, comprising a feature map segmenting unit that segments the feature map into the first area and the second area.

3. The information processing device according to claim 2, wherein the feature map segmenting unit segments the feature map into the first area and the second area such that the first area includes a redundant section and the second area includes a redundant section, both redundant sections overlapping each other.

4. The information processing device according to claim 3, wherein a size of the redundant section is determined based on a size of a filter and a stride, the filter and the stride being used in the computation process.

5. The information processing device according to claim 1, comprising:
an NN computation unit provided in correspondence to each layer in the neural network, the NN computation unit executing the computation process on the first area and on the second area;
an internal memory unit that stores a result of the computation process on the first area, the computation process being executed by the NN computation unit corresponding to a k-th layer in the neural network, and a result of the computation process on the second area, the computation process being executed by the NN computation unit corresponding to the k-th layer, at different points of time; and
a feature map synthesizing unit that synthesizes a result of the computation process on the first area, the computation process being executed by the NN computation unit corresponding to a (k+α)-th layer in the neural network, and a result of the computation process on the second area, the computation process being executed by the NN computation unit corresponding to the (k+α)-th layer.

6. The information processing device according to claim 5, wherein
results of the computation processes, the results being synthesized by the feature map synthesizing unit, are stored in an external memory device provided outside the information processing device, and
the results of the computation processes, the results being stored in the external memory device, are inputted to the NN computation unit corresponding to a (k+α+1)-th layer in the neural network.

7. The information processing device according to claim 5, wherein the NN computation unit corresponding to the (k+α+1)-th layer executes a convolutional process or pooling process, using a stride of 2 or more in size.

8. The information processing device according to claim 1, comprising:
a feature map segmenting unit that segments the feature map into a plurality of areas including at least the first area and the second area;
an NN computation unit provided in correspondence to each layer in the neural network, the NN computation unit executing the computation process on each of the plurality of areas;
an internal memory unit that stores a result of the computation process executed by the NN computation unit; and
a feature map synthesizing unit that synthesizes results of the computation process that the NN computation unit corresponding to a given layer in the neural network has executed on each of the plurality of areas, the feature map synthesizing unit storing the synthesized computation process results in an external memory device provided outside the information processing device,
wherein a number of segmentations of the feature map by the feature map segmenting unit and a number of layers in the neural network, the layers being subjected to the computation process by the NN computation unit before the feature map synthesizing unit synthesizes the computation process results, are determined, based on at least one of: a memory capacity of the internal memory unit, a total amount of computations by the computation process by the NN computation unit, a data transfer band between the information processing device and the external memory device, and a variation in a data size between a point before the computation process by the NN computation unit and a point after the computation process by the NN computation unit.

9. An information processing device that executes a DNN computation by a neural network including a plurality of layers, the information processing device comprising:
a feature map segmenting unit that segments a feature map inputted to the neural network into a plurality of areas such that segmented areas each include redundant sections overlapping each other;
an NN computation unit provided in correspondence to each of the layers in the neural network, the NN computation unit executing a given computation process on each of the plurality of areas;
an internal memory unit that stores a result of the computation process executed by the NN computation unit; and
a feature map synthesizing unit that synthesizes results of the computation processes that the NN computation unit corresponding to a given layer in the neural network has executed on each of the plurality of areas, the feature map synthesizing unit storing the synthesized computation process results in an external memory device provided outside the information processing device,
wherein a size of the redundant section is determined based on a size of a filter and a stride, the filter and the stride being used in the computation process,
a number of segmentations of the feature map by the feature map segmenting unit and a number of layers in the neural network, the layers being subjected to the computation process by the NN computation unit before the feature map synthesizing unit synthesizes the computation process results, are determined, based on at least one of: a memory capacity of the internal memory unit, a total amount of computations by the computation process by the NN computation unit, a data transfer band between the information processing device and the external memory device, and a variation in a data size between a point before the computation process by the NN computation unit and a point after the computation process by the NN computation unit.

10. An onboard control device comprising:
the information processing device according to claim 1; and
an action plan setting unit that sets an action plan for a vehicle,
wherein the information processing device executes the computation process, based on sensor information on a surrounding situation of the vehicle, and
the action plan setting unit sets the action plan for the vehicle, based on a result of the computation process, the result being outputted from the information processing device.
